(19) United States
(12) Patent Application Publication
(10) Pub. No.: US 2020/0318579 A1
(43) Pub. Date: Oct. 8, 2020

(54) Evaporated Fuel Processing Apparatus

(71) Applicant: AISAN KOGYO KABUSHIKI KAISHA, Obu-shi (JP)

(72) Inventors: Yoshihiko HONDA, Obu-shi (JP); Masanobu SHINAGAWA, Nagoya-shi (JP); Hiroyuki TAKAHASHI, Nagoya-shi (JP)

(73) Assignee: AISAN KOGYO KABUSHIKI KAISHA, Obu-shi (JP)

(21) Appl. No.: 16/823,594

(22) Filed: Mar. 19, 2020

(30) Foreign Application Priority Data
Apr. 4, 2019 (JP) 2019-071952

(51) Int. Cl. F02M 25/08

(52) U.S. Cl. CPC F02M 25/0854; B60K 2015/03514; F02M 25/0836; F02M 25/089

(57) ABSTRACT

A canister includes a vapor port leading to a fuel tank, an atmospheric port leading to the atmosphere, a first purge port leading to a first purge passage, and a second purge port leading to a second purge passage. The vapor port is located farther from the second purge port than the first purge port.

### CROSS-REFERENCE TO RELATED APPLICATIONS

This application claims priority to Japanese patent application serial number 2019-071952 filed Apr. 4, 2019, which is hereby incorporated herein by reference in its entirety for all purposes.

### BACKGROUND

The present disclosure relates to an evaporated fuel processing apparatus.

An evaporated fuel processing apparatus for a vehicle, such as an automobile, may include a canister. The canister is configured to store adsorbents, which adsorb and desorb evaporated fuel generated in a fuel tank. Intake passages of the canister may communicate with an internal combustion engine via a purge passage (hereinafter, referred to as a first purge passage). The vehicle may be provided with a purge pump in the first purge passage, thereby promoting adsorbing and desorbing of the fuel in the canister. The purge pump communicates with the canister via another purge passage (hereinafter, referred to as a second purge passage). The evaporated fuel processing apparatus may perform a purge process and a circulation process. In the purge process, fuel desorbed from the canister is purged into the intake passages by the purge pump. In the circulation process, desorbed fuel drawn by the purge pump through the first purge passage is returned into the canister via the second purge passage.

### SUMMARY

According to one aspect of the present disclosure, an evaporated fuel processing apparatus may comprise a canister storing adsorbents configured to releasably adsorb evaporated fuel from a fuel tank. The canister may communicate with an intake passage of an internal combustion engine via a first purge passage. A purge pump may be disposed along a first purge passage. An opening/closing valve may be disposed along the first purge passage between the purge pump and the intake passage. The opening/closing valve and the canister may communicate with each other via a second purge passage. The canister may include a vapor port leading to the fuel tank, an atmospheric port leading to the atmosphere, a first purge port leading to the first purge passage, and a second purge port leading to the second purge passage. The second purge port may be located in a position farther from the vapor port than the first purge port.

With this structure, the heat of the adsorbents in the vicinity of the second purge port is less easily transmitted to adsorbents in the vicinity of the vapor port, as compared with the case where the second purge port is disposed closer to the vapor port than the first purge port. For example, the purge pump may return the desorbed fuel vapor to the canister via the second purge passage. Accordingly, the temperature of the adsorbents in the vicinity of the second purge port may be increased. Even in this case, it is possible to prevent the temperature of the adsorbents in the vicinity of the vapor port from increasing. The reduction in the adsorption performance of the adsorbents in the vicinity of the vapor port may be avoided.

According to another aspect of the present disclosure, an evaporated fuel processing apparatus may include a canister configured to store adsorbents for releasably adsorbing evaporated fuel from a fuel tank. The canister may communicate with an intake passage of an internal combustion engine via a first purge passage. A purge pump may be disposed along the first purge passage. An opening/closing valve may be disposed along the first purge passage between the purge pump and the intake passage. The opening/closing valve may communicate with the canister via a second purge passage. The canister may include a vapor port leading to the fuel tank, an atmospheric port leading to the atmosphere, a first purge port leading to the first purge passage, and a second purge port leading to the second purge passage. The canister may include adsorbent layer(s) comprising the adsorbents. The adsorbent layer(s) may include a second end face facing the second purge port and a vapor end face facing the vapor port. A distance between the vapor port and the vapor end face is greater than a distance between the second purge port and the second end face.

Therefore, the heat of the adsorbents in the vicinity of the second end face is less easily transferred to the adsorbents in the vicinity of the vapor end face, as compared with the structure where the distance between the vapor port and the vapor end face is substantially equal to the distance between the second purge port and the second end face. For example, the temperature of the adsorbents in the vicinity of the second purge port may be increased due to the desorbed fuel vapor returned to the canister. Even in this case, it is possible to prevent the temperature of the adsorbents in the vicinity of the vapor port from increasing. As a result, deterioration of the adsorption performance of the adsorbents may be avoided.

According to another aspect of the present disclosure, an evaporated fuel processing apparatus may include a canister configured to store adsorbents for releasably adsorbing evaporated fuel from a fuel tank. The canister may communicate with an intake passage of an internal combustion engine via a first purge passage. A purge pump may be disposed along the first purge passage. An opening/closing valve may be disposed along the first purge passage between the purge pump and the intake passage. The opening/closing valve communicates with the canister via a second purge passage. The canister may include a vapor port leading to the fuel tank, an atmospheric port leading to the atmosphere, a first purge port leading to the first purge passage, and a second purge port leading to the second purge passage. The canister may include adsorbent layer(s) comprising of the adsorbents. The adsorbent layers may be partitioned by a partition into a region facing the second purge port and a region facing the vapor port. The partition may be configured so that a thermal conductivity of the partition is lower than a thermal conductivity of a case member of the canister.

Therefore, the heat of the adsorbents in the vicinity of the second purge port is less easily transferred to the adsorbents in the vicinity of the vapor port than when the thermal conductivity of the partition is substantially equal to the thermal conductivity of the case member of the canister. For example, the temperature of the adsorbents in the vicinity of the second purge port may be increased due to the desorbed fuel vapor returned to the canister. Even in this case, it is possible to prevent the temperature of the adsorbents in the vicinity of the vapor port from increasing. The reduction in the adsorption performance of the adsorbents in the vicinity of the vapor port may thus be avoided.

According to another aspect of the present disclosure, the opening/closing valve may be a three-way valve. This makes it possible to switch flow passages between the second purge passage and the first purge passage downstream portion without complicated piping.

According to another aspect of the present disclosure, the canister may include a first purge air chamber adjacent to the first purge port and a second purge air chamber adjacent to the second purge port. The first purge air chamber and the second purge air chamber may be partitioned by the partition. The first purge air chamber and the second purge air chamber communicate with each other via an adsorbent layer comprising the adsorbents. Consequently, direct air leakage through and between the first purge air chamber and the second purge air chamber may be prevented. As a result, the adsorbed fuel vapor may be more intensively desorbed from the adsorbents in the vicinity of the first purge port.

### BRIEF DESCRIPTION OF THE DRAWINGS

FIG. 1 is a schematic view of an embodiment of a fuel supply system in accordance with the principles described herein.

FIG. 2 is a cross-sectional view of the canister shown in FIG. 1.

FIG. 3 is a cross-sectional view of an embodiment of a canister in accordance with the principles described herein that can be used with the fuel supply system of FIG. 1.

FIG. 4 is a cross-sectional view of an embodiment of a canister in accordance with the principles described herein that can be used with the fuel supply system of FIG. 1.

FIG. 5 is a top view of the canister of FIG. 2 as viewed from a direction of an arrow V.

FIG. 6 is a top view of an embodiment of a canister in accordance with the principles described herein that can be used with the fuel supply system of FIG. 1.

### DETAILED DESCRIPTION

As previously described, an evaporated fuel processing apparatus may perform a purge process and a circulation process. In the purge process, fuel desorbed from the canister is purged into the intake passages by the purge pump. In the circulation process, desorbed fuel drawn by the purge pump through the first purge passage is returned into the canister via the second purge passage. The desorbed fuel vapors flowing through the second purge passage return to the canister through the purge pump. Therefore, the fuel vapors in the second purge passage have a higher temperature than the fuel vapors before entering the purge pump from the canister. Further, the adsorbents near a port of the canister communicating with the second purge passage generate heat due to adsorption of the fuel vapors. Consequently, the adsorption performance of the adsorbents may be reduced near the port communicating with the second purge passage. Additionally, the adsorption performance of the entire canister may possibly be reduced due to the heat of the adsorbents near the port communicating with the second passage being transmitted to the entire canister.

Therefore, for an evaporated fuel processing apparatus configured to perform a circulation process of the desorbed fuel vapors, there has been a need for a structure preventing a reduction of the adsorption performance of the canister.

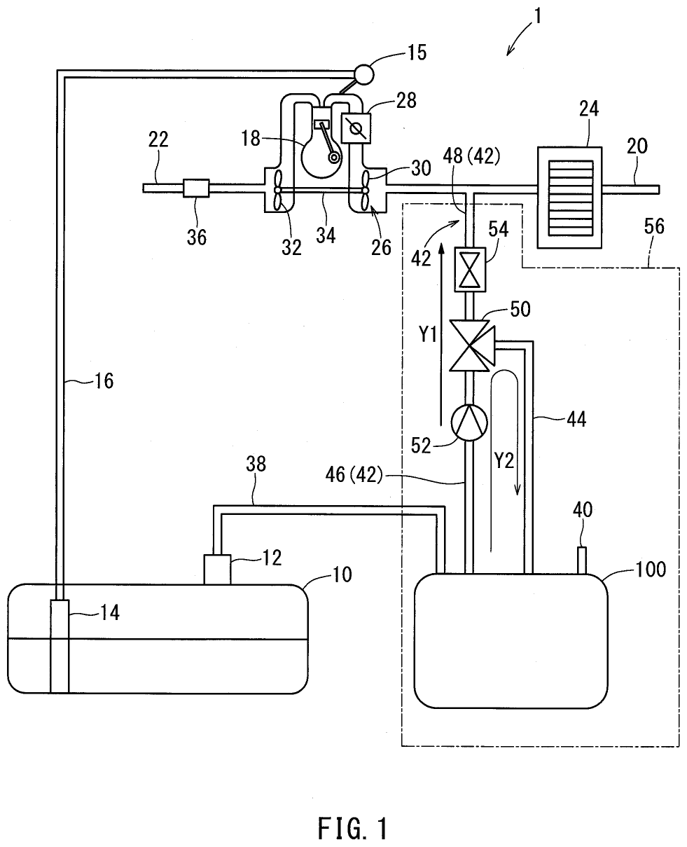

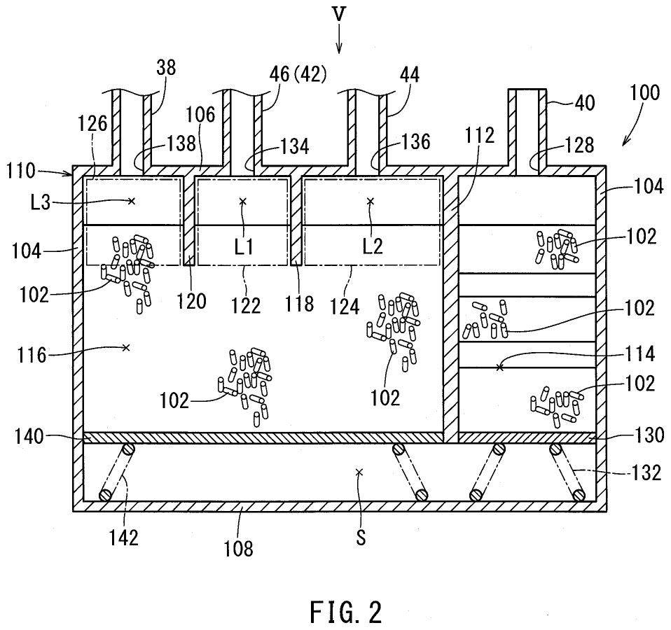

A first embodiment will be described with reference to FIG. 1 and FIG. 2. As shown in FIG. 1, a fuel supply system 1 may be mounted on a vehicle, such as an automobile. A cutoff valve 12 may be disposed at an upper wall of a fuel tank 10. A fuel pump 14 may be positioned within the fuel tank 10. An outlet port (not shown) of the fuel pump 14 may be connected to one end of a fuel passage 16. The other end of the fuel passage 16 may be connected to an injector 15. The fuel pump 14 is configured to supply fuel, such as gasoline, to an engine 18 via the fuel passage 16. The engine 18 (for instance, an internal combustion engine) may be, for example, a known gasoline engine. Each of the cylinders (not shown) of the engine 18 communicates with an intake passage 20 and an exhaust passage 22.

As shown in FIG. 1, the intake passage 20 may be opened to the atmosphere at an upstream end distal the engine 18. The intake passage 20 may successively connect, from the upstream end to a downstream end, an air cleaner 24, a supercharger 26, a throttle valve 28, and the engine 18. The supercharger 26 may include a compressor 30 in the intake passage 20, a turbine 32 in the exhaust passage 22, and a shaft 34 connecting the compressor 30 and the turbine 32. The throttle valve 28 may be electronically controlled by an ECU (Engine Control Unit, not shown) such that an opening/closing amount can be adjusted in response to an operation of an acceleration pedal (not shown). The turbine 32, as a part of the supercharger 26, and a catalytic converter 36 may be connected to the exhaust passage 22. The catalytic converter 36 may include a casing, a carrier stored within the casing, and a three-way catalyst carried on the carrier containing, for example, platinum, palladium, rhodium, etc. (all of these are not shown). An end of the exhaust passage 22 opposite to the engine is opened to the atmosphere.

As shown in FIG. 1, one end of the cutoff valve 12 may be connected to one end of a vapor passage 38, which is connected to the canister 100. Evaporated fuel generated within the fuel tank 10 may be introduced to the canister 100 via the vapor passage 38. Adsorbents 102 (see FIG. 2) capable of adsorbing and desorbing the evaporated fuel may be stored within the canister 100. In addition to the above-described vapor passage 38, an atmospheric passage 40, a first purge passage 42, and a second purge passage 44 may be connected to the canister 100. The atmospheric passage 40 may have an opening, which is open to the atmosphere.

As shown in FIG. 1, the first purge passage 42 may include a first purge passage upstream portion 46 and a first purge passage downstream portion 48. One end of the first purge passage upstream portion 46 may be connected to the canister 100. The other end of the first purge passage upstream portion 46 may be connected to one of connection ports (e.g., an inlet port) of the three-way valve 50. The purge pump 52 may be provided in a midstream portion of a passage of the first purge passage upstream portion 46. A suction port of the purge pump 52 may be connected to the canister 100. The outlet port of the purge pump 52 may be connected to the three-way valve 50. One end of the first purge passage downstream portion 48 may be connected to one of the connection ports (e.g., an outlet port) of the three-way valve 50. The other end of the first purge passage downstream portion 48 may bifurcate into two branches. One end of the bifurcation may be connected to an air cleaner 24 of the intake passage 20. The other end of the bifurcation may be connected to the supercharger 26. A purge control valve 54 may be connected in the midstream portion of the first purge passage downstream portion 48. One end of the second purge passage 44 may be connected to the canister 100. The other end of the second purge passage 44 may be connected to one of the connection ports (e.g., an outlet port) of the three-way valve 50.

As shown in FIG. 1, the three-way valve 50 may be configured as a so-called flow-dividing type valve that is electrically connected to the ECU. The three-way valve 50 may be electronically controlled by the ECU so as to open one of the outlet ports and close the other outlet port. The purge pump 52 feeds the evaporated fuel to the inlet port of the three-way valve 50, via the first purge passage upstream portion 46. The three-way valve 50 may open one, or more, of the outlet ports to allow the desorbed fuel vapor to flow to the first purge passage downstream portion 48. Alternatively, the three-way valve 50 may open the other outlet port to allow the desorbed fuel to flow to the second purge passage 44. More specifically, the three-way valve 50 may switch the exhaust passage of the desorbed fuel vapor between the first purge passage downstream portion 48 and the second purge passage 44

The purge control valve 54 shown in FIG. 1 may also be electrically connected to the ECU and electronically controlled by the ECU. A purge process may be performed when the engine 18 is driven in a driving state where the air-fuel ratio is stable. In the purge process, the fuel adsorbed by the canister 100 may be introduced to the engine 18. The ECU controls the there-way valve 50 to open the outlet port of the three-way valve 50 connected to the first purge passage downstream portion 48.

On the other hand, a circulation process may be carried out when the engine 18 is driven in a driving state where the air-fuel ratio is unstable (a transient state, etc.) or when the engine 18 is stopped. Referring to FIG. 1, in the circulation process, the desorbed fuel vapor exhausted from the canister 100 returns to the canister 100, such that the fuel vapor effectively circulates. The ECU controls the three-way valve 50 to open the outlet port of the three-way valve 50 connected to the second purge passage 44. The ECU may also close the purge control valve 54. As can be understood from the above description, the fuel supply system 1 may include an evaporated fuel processing apparatus 56 as a circulation processing system for the evaporated fuel. The evaporated fuel processing apparatus 56 may include a canister 100, a purge pump 52, a three-way valve (which is an embodiment of an opening/closing valve) 50, and a purge control valve 54.

A first embodiment of the canister 100 will now be described with reference to FIG. 2. Hereinafter, each of the canisters according to the first to third embodiments will be described with reference to an upward, downward, left, and right directions of each depicted figure for convenience purposes. However, these directions are not necessarily intended to specify the directions of the canister when mounted on a vehicle. The canister 100 may include a casing 110 having a peripheral walls 104 defining lateral surfaces, an upper wall 106 defining a top surface, and a bottom wall 108 defining a bottom surface. The inside of the casing 110 may be partitioned into a first adsorption chamber 114 and a second adsorption chamber 116 by a partition wall 112.

As shown in FIG. 2, an upper region of the second adsorption chamber 116 may be partitioned into a first compartment 122, a second compartment 124, and a third compartment 126 by a first compartment wall 118 and a second compartment wall 120. The first compartment 122, the second compartment 124, and the third compartment 126 may extend downward from a bottom surface of the upper wall 106. The first compartment wall 118 and the second compartment wall 120 may have substantially the same dimension in the upward and downward direction. Adsorbents 102 are stored in both the first adsorption chamber 114 and the second adsorption chamber 116. One example of an adsorbent 102 may be granular activated carbon.

As shown in FIG. 2, an atmospheric port 128, communicating with the first adsorption chamber 114, may be defined in the upper wall 106. The atmospheric port 128 may be connected to the atmospheric passage 40. The first adsorption chamber 114 may be partitioned into a plurality of layers disposed in the up and down direction by filter members (not labeled). The plurality of layers may alternately include air layers without the adsorbents 102 and adsorbent layers filled with the adsorbents 102. The filter members may have air-permeability.

As shown in FIG. 2, a lower opening of the atmospheric port 128 may be covered with a filter member. More specifically, the upper side of the uppermost layer and the atmospheric port 128 is partitioned by the filter member. The uppermost layer within the first adsorption chamber 114 is an air layer. The lowermost layer within the first adsorption chamber 114 is an adsorbent layer. The lower side of the lowermost layer may be supported by a first supporting plate 130. The first supporting plate 130 may have air-permeability. A biasing member such as a coil spring 132 may be provided between the first supporting plate 130 and the bottom wall 108. A position of the coil spring 132 may be optionally determined in a left-right direction. The coil spring 132 elastically deforms and biases the first supporting plate 130 upward toward the upper wall 106, so as to support the supporting plate 130.

As shown in FIG. 2, a first purge port 134, a second purge port 136, and a vapor port 138 may be formed in corresponding locations of the upper wall 106 of the first compartment 122, second compartment 124, and third compartment 126, respectively. The first purge port 134, the second purge port 136, and the vapor port 138 may communicate with the first purge passage 42, the second purge passage 44, and the vapor passage 38, respectively. The adsorbents 102 may be continuously disposed in the second adsorption chamber 116 in the vertical direction, unlike the layering of the first adsorption chamber 114.

In the first embodiment, the atmospheric port 128, the first purge port 134, the second purge port 136, and the vapor port 138 may be arranged and structured similar to that shown in FIG. 2. Specifically, the atmospheric port 128, the second purge port 136, the first purge port 134, and the vapor port 138 are arranged in this order from the right. According to this arrangement and structure, the second purge port 136 may be arranged in a position further spaced apart from the vapor port 138 than the first purge port 134. For instance, a distance between the vapor port 138 and the first purge port 134 is less than a distance between the vapor port 138 and the second purge port 136. This arrangement and structure constitutes one feature of the first embodiment.

As shown in FIG. 2, filter members (not shown) may be disposed above each of the adsorbents 102 in the first compartment 122, the second compartment 124, and the third compartment 126. Accordingly, a vertical position and height of an upper end face of the adsorbent layer containing the adsorbents 102 may be determined. The upper end faces of each of the adsorbent layers of the first compartment 122, the second compartment 124, and the third compartment 126 are disposed with substantially the same position and height in the vertical direction. For example, the upper end face of each of the adsorbent layers may be disposed at an intermediate level of the first compartment wall 118 and/or the second compartment wall 120 in the vertical direction. Air layers L1, L2, L3 may be provided over each of the filter members. The air layers L1, L2, L3 may contact the first purge port 134, the second purge port 136, and the vapor port 138, respectively, within the first compartment 122, the second compartment 124, and the third compartment 126, respectively.

As shown in FIG. 2, a lower end face of the adsorbent layer in the second adsorption chamber 116 may be located in the vicinity of the lower end of the partition wall 112 in the vertical direction. The upper region of the adsorbent layer in the second adsorption chamber 116 may be separated by the first compartment wall 118 and the second compartment wall 120 into the first compartment 122, the second compartment 124, and the third compartment 126, respectively. On the other hand, a lower region of the adsorbent layer in the second adsorption chamber 116, which is located below the first compartment wall 118 and the second compartment wall 120, is continuous. The first compartment 122, the second compartment 124, and the third compartment 126 are therefore in communication via the lower region of the adsorbent layer. The first compartment 122 may include a first purge air chamber (air layer) L1. The second compartment 124 may include a second purge air chamber (air layer) L2. The third compartment 126 may include a third purge air chamber (air layer) L3.

As shown in FIG. 2, in the second adsorption chamber 116, the lower end face of the adsorbent layer may be supported by a second supporting plate 140. The second supporting plate 140 is air-permeable, for example by having a plurality of holes formed therein. The second supporting plate 140 may be biased upward by a biasing member such as a coil spring 142. The coil spring 142 is positioned between the second supporting plate 140 and the bottom wall 108, and is positioned in the left-right direction based on preferable locations.

As shown in FIG. 2, a space S may be formed between the partition wall 112 and the bottom wall 108. The space S mutually communicates the first adsorption chamber 114 and the second adsorption chamber 116. Therefore, a generally U-shaped fluid passage is defined in the casing 110 through which the fluid, i.e., the fuel vapor, flows.

As shown in FIG. 2, the evaporated fuel generated in the fuel tank 10 may be introduced into the canister 100 from the vapor port 138, via the vapor passage 38. The evaporated fuel is then adsorbed by the adsorbents 102 in the third compartment 126. The adsorbed fuel vapor in the third compartment 126 may be diffused by the adsorbents 102 toward the downward direction. The diffused adsorbed fuel vapor further diffuses into the main/contiguous area inside the second adsorption chamber 116 after passing by the second compartment wall 120. Due to the diffusion, a concentration gradient of the evaporated fuel on the adsorbents 102 may result. For instance, the concentration of the evaporated fuel on the adsorbents 102 in the second adsorption chamber 116 may reduce as the distance from the third compartment 126 is increased.

Referring to FIG. 2, only a small amount of the fuel vapor desorbed from the lower side of the second adsorption chamber 116 into the space S is adsorbed by the adsorbents 102 in the lowermost layer of the first adsorption chamber 114 when neither the purge process nor circulation process is being performed. The adsorbent layers and the air layers are alternately arranged in the first adsorption chamber 114. The now adsorbed fuel vapor is thus diffused in the adsorbents 102 in the lowermost layer. The fuel vapor must then be desorbed from the upper side of the lowermost layer in order to reach the atmospheric port 128. This process then continues for the other adsorbent/air layers. For instance, it is also necessary that the rest of the adsorbent layers adsorb the fuel vapor from the lower side of the adsorbent layer, that the adsorbed fuel vapor is diffused within the adsorbent layer, and that the fuel vapor is desorbed from the upper side of the adsorbent layer. Therefore, only a small amount of the evaporated fuel may be exhausted from the atmospheric port 128 to the atmosphere, or the evaporated fuel may not be exhausted in the atmosphere at all.

Referring to FIG. 2, when the above-mentioned purge process is performed, air is introduced from the atmospheric port 128 into the canister 100. Subsequently, the air flows, in order, through the first adsorption chamber 114, the space S, the second adsorption chamber 116, the first compartment 122, and the first purge port 134. The second adsorption chamber 116 is primarily located below the first compartment wall 118 and the second compartment wall 120. During the purge process, the fuel vapor adsorbed to the adsorbent 102 within the first compartment 122 is desorbed into the air layer L1 of the first compartment 122. Afterwards, the desorbed fuel vapor is introduced into the intake passage 20 via the first purge passage upstream portion 46 and the first purge passage downstream portion 48, as indicated by a first arrow Y1 in FIG. 1.

Consequently, the concentration of the evaporated fuel on adsorbents 102 is reduced in the first compartment 122. As a result, another concentration gradient of the evaporated fuel may be created between the adsorbents 102 in the first compartment 122 and the adsorbents 102 in the third compartment 126. Due to the creation of this concentration gradient, the evaporated fuel flows in a U-shaped, direction detouring around the second compartment wall 120, thereby promoting diffusion of the adsorbed fuel vapor from the third compartment 126 into the first compartment 122. The concentration of the evaporated fuel of the adsorbents 102 in the third compartment 126 may thus be further reduced.

When the above-described circulation process is performed, the air flows as indicated by a second arrow Y2 in FIG. 1. Specifically, as shown in FIG. 2, the air may flow from the first purge port 134 out of the canister 100, and flow from the second purge port 136 into the canister 100. At this time, the fuel vapor adsorbed by the adsorbents 102 in the first compartment 122 may be desorbed into the air layer L1 of the first compartment 122. Subsequently, as indicated by the second arrow Y2 in FIG. 1, the desorbed fuel vapor passes through the first purge passage upstream portion 46, and is then introduced into the air layer L2 in the second compartment 124, via the second purge port 136 (shown in FIG. 2). The fuel vapor is then adsorbed by the adsorbent materials 102 in the second compartment 124.

Referring to FIG. 2, a concentration gradient of the evaporated fuel is created between the adsorbents 102 in the first compartment 122 and the adsorbents 102 in the third compartment 126. This concentration gradient is created at least in part due to the evaporated fuel concentration of the adsorbents 102 in the first compartment 122 being reduced. Due to the creation of this concentration gradient, diffusion of the adsorbed fuel vapor from the third compartment 126 into the first compartment 122 may be promoted, similar to the purge process. As a result, the evaporated fuel concentration of the adsorbents 102 in the third compartment 126 reduces.

In general, adsorption of the evaporated fuel by the adsorbents 102 is accompanied by generation of heat, and desorption of the fuel vapor from the adsorbents 102 is accompanied by absorption of heat. Therefore, the temperature of the adsorbents 102 in the first compartment 122 becomes lower than the temperature of its surroundings during the purge process and the circulation process. Accordingly, the adsorption performance of the adsorbents 102 in the first compartment 122 becomes higher than the adsorbents 102 in the other locations. This improvement in the adsorption performance promotes diffusion of the adsorbed fuel vapor from the inside of the second compartment 124 and/or the third compartment 126 into the inside of the first compartment 122. The adsorption performance of the adsorbents is typically evaluated, for example, by adsorption capacity per unit mass.

Further, during the purge process and the circulation process, the temperature of the adsorbents 102 in the first compartment 122 is lower than that of its surroundings. The temperature of the desorbed fuel vapor drawn by the purge pump 52 from the first compartment 122 is thus also relatively low. The purge pump 52 can be cooled with this low temperature fuel vapor.

When the purge pump 52 shown in FIG. 1 is continuously driven, its temperature will rise. In response, the temperature of the desorbed fuel vapor exhausted from the purge pump 52 will also rise. Further, the adsorbents 102 in the second compartment 124 shown in FIG. 2 adsorb the higher temperature exhausted fuel vapor during the circulation process. Therefore, the temperature of the adsorbents 102 in the second compartment 124 becomes higher, as a result of the circulation process, than the temperature of the adsorbents 102 located in other locations. A high concentration of evaporated fuel generated in the fuel tank 10 flows from the vapor port 138 into the third compartment 126. Therefore, a reduction in the adsorption performance of the adsorbents 102 in the third compartment 126 is not desirable.

As shown in FIG. 2, in the first embodiment, the second purge port 136 may be located at a position such that the vapor port 138 is located farther from the second purge port 136 than the first purge port 134. For instance, the distance between the vapor port 138 and the second purge port 136 is greater than the distance between the vapor port 138 and the first purge port 134. Therefore, the heat of the adsorbents 102 in the second compartment 124 is less easily transmitted to the adsorbents 102 in the third compartment 126, as compared to when the vapor port 138 is located closer to the second purge port 136 than the first purge port 134. As a result, it is possible to prevent the adsorption performance of the adsorbents 102 from being deteriorated in the third compartment 126 when the circulation process is performed for longer periods of time.

The second purge passage 44 shown in FIG. 2 may be opened or closed by a three-way valve 50, shown in FIG. 1. This makes it possible to switch flow passages between the second purge passage 44 and the first purge passage downstream portion 48 without complicated piping.

As shown in FIG. 2, the first compartment 122 and second compartment 124 may be formed by being partitioned by the first compartment wall 118. In the first compartment 122 and the second compartment 124, the air layer L1 and the air layer L2 may be provided in contact with the first purge port 134 and the second purge port 136, respectively. The air layer L1 in the first compartment 122 communicates with the air layer L2 in the second compartment 124 via the adsorbents 102. The adsorbed fuel vapor is uniformly desorbed over the upper end face of the adsorbent layer of the adsorbents 102 in the first compartment 122 since the air layer L1 is provided. At the same time, the desorbed fuel vapor from the fuel pump can be uniformly adsorbed over the upper end face of the adsorbent layer of the adsorbents 102 in the second compartment 124. Therefore, it is possible to perform adsorption and desorption more effectively than when one or more air chambers is not provided. Further, the air layer L1 in the first compartment 122 communicates with the air layer L2 in the second compartment 124 via the adsorbents 102. Consequently, direct air leakage between the first compartment 122 and the second compartment 124 may be prevented, thereby allowing adsorbed fuel vapor to be intensively desorbed from the adsorbents 102 in the first compartment 122.

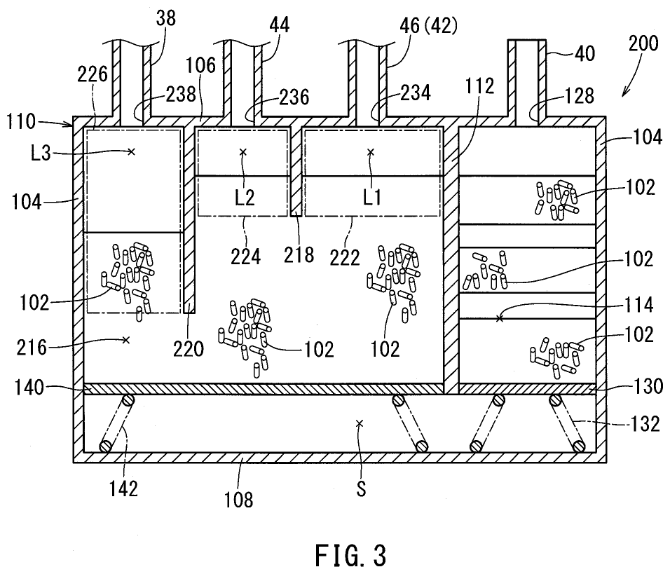

A second embodiment will now be described with reference to FIG. 1 and FIG. 3. In the second embodiment, the canister 100 provided in the fuel supply system 1 of the first embodiment is replaced with a canister 200 having some structural differences than that of the canister 100 of the first embodiment. Therefore, in FIG. 3, the substantially similar components as the first embodiment are denoted with the same reference numerals as the first embodiment and description thereof may be omitted.

As shown in FIG. 3, the inside of a casing 110 may be partitioned by a partition wall 112 into a first adsorption chamber 114 and a second adsorption chamber 216. An upper region of the second adsorption chamber 216 may be partitioned by a first compartment wall 218 and a second compartment wall 220 into a first compartment 222, a second compartment 224, and a third compartment 226. The first compartment wall 218 of this embodiment may have substantially the same length as the first compartment wall 118 according to the first embodiment. The first compartment wall 218 of the second embodiment may extend downward from a lower surface of an upper wall 106. A second compartment wall 220 of the second embodiment may have a greater vertical dimension than the first compartment wall 218, and may extend downward from the lower surface of the upper wall 106. The adsorbents 102 may be stored in the first adsorption chamber 114 and the second adsorption chamber 216.

As shown in FIG. 3, a first purge port 234, a second purge port 236, and a vapor port 238 may be formed in the corresponding locations of the upper wall 106 of the first compartment 222, the second compartment 224, and the third compartment 226, respectively. The first purge port 234, the second purge port 236, and the vapor port 238 may communicate with the first purge passage 42, the second purge passage 44, and the vapor passage 38, respectively. In the second embodiment, different from the first embodiment, the second purge port 236 may be located closer to the vapor port 238 than the first purge port 234. As shown in FIG. 3, each of the ports 128, 234, 236, 238 according to the second embodiment may thus be arranged in the order of the atmospheric port 128, the first purge port 234, the second purge port 236, and the vapor port 238, moving from the right to the left.

As shown in FIG. 3, the adsorbents 102 may be continuously filled in the second adsorption chamber 216 in the vertical direction. Filter members (not shown) may be disposed on upper end faces of the adsorbent layer in the first compartment 222 and the second compartment 224. The filter member may be used to determine a vertical level of the upper end faces of the adsorbent layer, although other ways of setting the vertical level may be used. The upper end face of each of the adsorbent layers in the first compartment 222 and the second compartment 224 may be located at substantially the same level in the vertical direction. For example, the upper end face of each of the adsorbent layers may be located in an intermediate level of the first compartment wall 218 in the vertical direction.

As shown in FIG. 3, a filter member (not shown) may be disposed on the upper end face of the adsorbent layer of the adsorbents 102 in the third compartment 226. The filter member may serve to determine the level of the upper end face of the adsorbent layer in the vertical direction, although other ways of setting the vertical level may be used. The upper end face of the adsorbent layer in the third compartment 226 may be positioned below the upper end faces of the adsorbent layers in the first compartment 222 and the second compartment 224 in the vertical direction. The upper end face of the adsorbent layer in the third compartment 226 may be located above a lower end of the second compartment wall 220. The air layers L1, L2, L3 may be provided in the first compartment 222, the second compartment 224, and the third compartment 226, respectively, above the adsorbent layer. Filter member(s) may be positioned within one or more of the air layers L1, L2, L3. The air layers L1, L2, L3 may come in contact with the first purge port 234, the second purge port 236, and the vapor port 238, respectively.

Also in the second embodiment, as shown in FIG. 3, the upper region of the second adsorption chamber 216 may be partitioned by the first compartment wall 218 and the second compartment wall 220 into the first compartment 222, the second compartment 224, and the third compartment 226. The second adsorption chamber 216 may have a lower region below the first compartment wall 218 and the second compartment wall 220. The lower region is continuous, without being partitioned by the compartment walls. The first compartment 222, the second compartment 224, and the third compartment 226 communicate with each other via the adsorbents 102 in the lower region of the second adsorption chamber 216. The first compartment 222 may include a first purge air chamber (air layer) L1, the second compartment 224 may include a second purge air chamber (air layer) L2, and the third compartment 226 may include a third purge air chamber (air layer) L3.

Also in the second embodiment, as shown in FIG. 3, the lower end face of the adsorbent layer of the adsorbents 102 in the second adsorption chamber 216 may be supported by the second supporting plate 140. The second supporting plate 140 has, for example, holes, and is thus air-permeable. The second supporting plate 140 is upwardly biased by a coil spring 142.

As shown in FIG. 3, a space S may be defined below the second supporting plate 140 and the first supporting plate 130, as well as above the bottom wall 108. The space S extends through and between the bottom wall 108 and a lower end of the partition wall 112, which divides the first adsorption chamber 114 and the second adsorption chamber 216. The space S mutually communicates the first adsorption chamber 114 and the second adsorption chamber 216. Therefore, a U-shaped fluid passage is defined in the casing 110 through which the fluid, i.e., the evaporated fuel, flows.

As shown in FIG. 3, the evaporated fuel generated in the fuel tank 10 may be introduced into the canister 200 from the vapor port 238, via the vapor passage 38, similar to the first embodiment. The evaporated fuel is then adsorbed by the adsorbents 102 in the third compartment 226. The adsorbed fuel vapor may be diffused by the adsorbents 102 toward the downward direction in the third compartment 226. The diffused adsorbed fuel vapor further diffuses into the entire area inside of the second adsorption chamber 216, after passing the second compartment wall 220. Due to the diffusion, a concentration gradient of the adsorbed fuel vapor on the adsorbents 102 may be created that reduces in the second adsorption chamber 216 as the distance from the third compartment 226 increases.

Referring to FIG. 3, when the above-mentioned purge process is performed, air is introduced from the atmospheric port 128 into the canister 200. Subsequently, the air flows, in order, through the first adsorption chamber 114, the space S, the lower portion of the second adsorption chamber 216, the first compartment 222, and the first purge port 234. This lower portion of the second adsorption chamber 216 is located below the first compartment wall 218. At this time, the fuel vapor adsorbed by the adsorbents 102 within the first compartment 222 is desorbed into the air layer L1 of the first compartment 222. Afterwards, the desorbed fuel vapor is introduced into the intake passage 20, via the first purge passage upstream portion 46 and the first purge passage downstream portion 48, as indicated by the first arrow Y1 in FIG. 1.

Consequently, the fuel vapor concentration of the adsorbents 102 reduces in the first compartment 122. As a result, the adsorbed fuel vapor concentration of the adsorbents 102 in the third compartment 226 becomes relatively higher and the adsorbed fuel vapor concentration of the adsorbents 102 in the first compartment 222 becomes relatively lower. In other words, anther concentration gradient of the adsorbed fuel vapor may be created between the adsorbents 102 in the first compartment 222 and the adsorbents 102 in the third compartment 226. Due to the creation of the concentration gradient, the adsorbed fuel vapor flows along a U-shaped passage detouring around the second compartment wall 220. Accordingly, diffusion of the adsorbed fuel vapor from the third compartment 226 into the first compartment 222 is promoted, thereby reducing the concentration of the adsorbed fuel vapor in the third compartment 226.

When the above-described circulation process is performed, the air flows as indicated by the second arrow Y2 in FIG. 1. Specifically, as shown in FIG. 2, the air may flow from the first purge port 234 out of the canister 100, and may flow from the second purge port 236 into the canister 100. At this time, the fuel vapor adsorbed by the adsorbents 102 in the first compartment 222 may be desorbed into the air layer L1 of the first compartment 222. Subsequently, as indicated by the second arrow Y2 in FIG. 1, the desorbed fuel vapor flows into the first purge passage upstream portion 46 and the second purge passage 44. Afterwards, the desorbed fuel vapor is introduced into the air layer L2 in the second compartment 224, via the second purge passage 236 as shown FIG. 3. Subsequently, the desorbed fuel vapor is adsorbed by the adsorbents 102 in the second compartment 224.

Referring to FIG. 3, a concentration gradient of the adsorbed fuel vapor is created between the adsorbents 102 in the first compartment 222 and the adsorbents 102 in the third compartment 226 in the circulation process. For instance, a concentration gradient is created as the adsorbed fuel vapor concentration of the adsorbents 102 in the first compartment 222 is reduced. Due to the creation of this concentration gradient, diffusion of the adsorbed fuel vapor from the third compartment 226 into the first compartment 222 may be promoted.

Further, referring to FIG. 3, in both the purge process and the circulation process, the temperature of the adsorbents 102 in the first compartment 222 is lower than the surrounding areas, similar to the first embodiment. Consequently, the adsorption performance of the adsorbents 102 in the first compartment 222 is improved compared to that of the adsorbents 102 in the other locations. Due to such an improvement in the adsorption performance, diffusion of the adsorbed fuel vapor from the adsorbents 102 in the second compartment 224 and/or the third compartment 226 to the adsorbents 102 in the first compartment 222 will be promoted.

Further, in both the purge process and the circulation process, the temperature of the adsorbents 102 in the first compartment 222 is lower than the surrounding areas. Accordingly, the temperature of the desorbed fuel vapor drawn into the purge pump 52 from the first compartment 222 is also relatively lower. The purge pump 52 can thereby be cooled by the desorbed fuel vapor having a lower temperature.

However, when the purge pump 52 shown in FIG. 1 is continuously driven, its temperature will likely rise. In response, the temperature of the desorbed fuel vapor exhausted from the purge pump 52 will correspondingly rise. Further, the adsorbents 102 in the second compartment 224 shown in FIG. 3 adsorb the desorbed fuel vapors during the circulation process. Therefore, the temperature of the adsorbents 102 in the second compartment 224 become relatively higher during the circulation process, as compared to the temperature of the adsorbents 102 located in the other locations. Evaporated fuel of high concentration generated in the fuel tank 10 flows from the vapor port 238 in the third compartment 226. Therefore, a reduction in the adsorption performance of the adsorbents 102 in the third compartment 226 is not desirable.

As described in the first embodiment, typically, the vapor port 138 may be located farther from the second purge port 136 than the first purge port 134. However, as shown in the embodiment of FIG. 3, the vapor port 238 may be located nearer the second purge port 236 than the first purge port 234. This arrangement of parts may be preferable, as compared to that of the first embodiment, in certain situations, for instance due to the arrangement of components constituting the fuel supply system 1, and also the other components for a vehicle equipped with the fuel supply system 1.

As shown in FIG. 3, a third distance from the vapor port 238 to the upper side of the adsorbent layer facing the vapor port 238 is greater than the second distance from the second purge port 236 to the upper side of the adsorbent layer facing the second purge port 236. Accordingly, the heat of the adsorbents 102 in the second compartment is less easily transferred to the adsorbents 102 in the third compartment 226, as compared with the case where the third distance and the second distance are approximately equal.

Alternatively, as shown in FIG. 3, the second compartment wall 220 may have a greater length than the first compartment wall 218. Therefore, in this structure, the transfer distance of the heat of the adsorbents 102 in the second compartment 224 to the adsorbents 102 in the third compartment 226 becomes greater, as compared with the case where the second compartment wall 220 and the first compartment wall 118 are approximately the same in length, for instance as shown in FIG. 2. As a result, the heat of the adsorbents in the second compartment 224 is less easily transmitted to the adsorbents 102 in the third compartments 226. Therefore, it is possible to prevent the adsorption performance of the adsorbents 102 in the third compartment from being deteriorated, even when the circulation process is performed for longer periods of time.

The second purge passage 44 shown in FIG. 3 may be opened or closed by the three-way valve 50 shown in FIG. 1. This makes it possible to switch flow passages between the second purge passage 44 and the first purge passage downstream portion 48 without complicated piping.

As shown in FIG. 3, the air layer L1 in the first compartment 222 may communicate with the air layer L2 in the second compartment 224 via the adsorbents 102. The adsorbed fuel vapor may be uniformly desorbed by the upper end face of the adsorbent layer of the adsorbents 102 in the first compartment 222 since the air layer L1 is provided. At the same time, the evaporated fuel can be uniformly adsorbed by the upper end face of the adsorbent layer of the adsorbents 102 in the second compartment 224 since the air layer L2 is provided. Therefore, it is possible to perform adsorption and desorption more effectively than when air chambers are not provided. Further, the air layer L1 in the first compartment 222 may only communicate with the air layer L2 in the second compartment 224 via the adsorbents 102. Consequently, direct leakage between the first compartment 222 and the second compartment 224 may be prevented. Accordingly, the adsorbed fuel vapor may be more intensively desorbed from the adsorbents 102 in the first compartment 222.

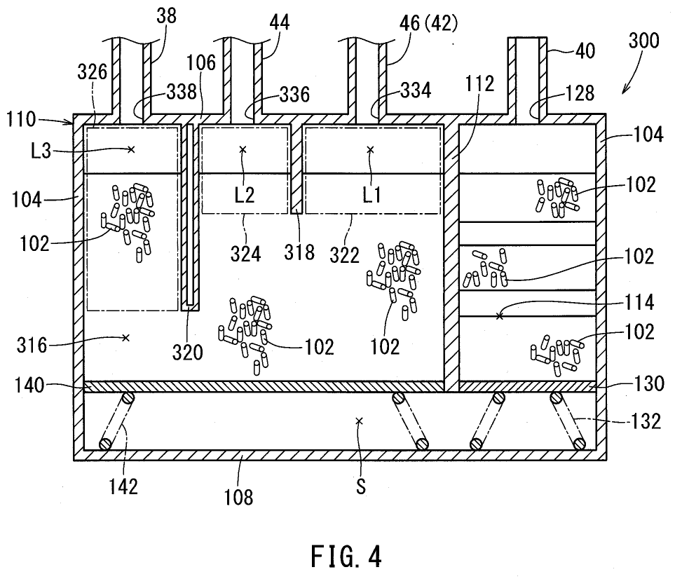

A third embodiment will be described with reference to FIG. 1 and FIG. 4. In the third embodiment, the canister 100 provided in the fuel supply system 1 according to the first embodiment is replaced with a canister 300 having some structural differences. Therefore, with regards to FIG. 4, substantially similar components as the first embodiment are denoted with the same reference numerals as the first embodiment and description thereof will be omitted.

As shown in FIG. 4, the inside the casing 110 of the canister 300 may be partitioned by a partition wall 112 into a first adsorption chamber 114 and a second adsorption chamber 316. An upper region of the second adsorption chamber 316 may be partitioned by a first compartment wall 318 and a second compartment wall 320 into a first compartment 322, a second compartment 324, and a third compartment 326. The first compartment wall 318 may have substantially the same length as the first compartment wall 118 according to the first embodiment and may extend downward from a lower surface of an upper wall 106. A second compartment wall 320 may have a greater vertical dimension than the first compartment wall 318 and may extend downward from the lower surface of the upper wall 106.

As shown in FIG. 4, the second compartment wall 320 may be formed of the same resin (for example, nylon) as a casing (case member) 110, the partition wall 112, and the first compartment wall 318. The second compartment wall 320 may have a cavity inside. Generally, the thermal conductivity of air is lower than that of resin. The thermal conductivity of the second compartment wall 320, which has a cavity formed therein, is therefore lower than that of the casing 110, the partition wall 112, and/or the first compartment wall 318, all of which do not have a cavity formed therein. More specifically, the thermal conductivity of the second compartment wall 320 in a direction across the cavity (for example, left-to-right direction) may be lower than that of the casing 110, the partition wall 112, and/or the first compartment wall 318. Other ways of modifying the thermal conductivity, as compared to the other components, of the second compartment wall 320 may be implemented. For example, a material different than that of the other components may be used, a layering structure may be implemented, etc. The adsorbents 102 may be stored in the first adsorption chamber 114 and the second adsorption chamber 316.

As shown in FIG. 4, a first purge port 334, a second purge port 336, and a vapor port 338 may be formed in the corresponding locations of the upper wall 106 of the first compartment 322, the second compartment 324, and the third compartment 326, respectively. The first purge port 334, the second purge port 336, and the vapor port 338 may communicate with the first purge passage 42, the second purge passage 44, and the vapor passage 38, respectively. In the third embodiment, similar to the above-described second embodiment, the vapor port 338 is located closer to the second purge port 336 than the first purge port 334. As shown in FIG. 3, each of the ports 128, 334, 336, 338 according to the third embodiment may thus be arranged in the order of the atmospheric port 128, the first purge port 334, the second purge port 336, and the vapor port 338, moving from the right to the left.

As shown in FIG. 4, the adsorbents 102 may be continuously filled in the second adsorption chamber 316 over the vertical direction. The upper end faces of the adsorbent layer of the adsorbents 102 in each of the first compartment 322, the second compartment 324, and the third compartment 326 may be located at substantially the same position in the vertical direction. For example, the upper end faces of the adsorbent layer may be located at an intermediate level of the first compartment wall 318 in the vertical direction. The air layers L1, L2, L3 may be provided in the first compartment 322, the second compartment 324, and the third compartment 326, respectively, above the adsorbent layer. The air layers L1, L2, L3 may come in contact with the first purge port 334, the second purge port 336, and the vapor port 338, respectively.

As shown in FIG. 4, the upper region of the second adsorption chamber 316 may be partitioned by the first compartment wall 318 and the second compartment wall 320 into the first compartment 322, the second compartment 324, and the third compartment 326. The lower region of the second adsorption chamber 316 may be located below the first compartment wall 318 and the second compartment wall 320 (compartment means). The lower region of the second adsorbent chamber 316 is continuous, without being partitioned by the compartment wall(s). The first compartment 322, the second compartment 324, and the third compartment 326 communicate with each other via the adsorbents 102 in the lower region of the second adsorption chamber 316. The first compartment 322 may include a first purge air chamber (air layer) L1, the second compartment 324 may include a second purge air chamber (air layer) L2, and the third compartment 326 may include a third purge air chamber (air layer) L3.

As shown in FIG. 4, the lower end face of the adsorbent layer of the adsorbents 102 in the second adsorption chamber 316 may be supported by the second supporting plate 140, which has air-permeability. The second supporting plate 140 is upwardly biased by a coil spring 142.

As shown in FIG. 4, a space S may be defined below the second supporting plate 140 and the first supporting plate 130, as well as above the bottom wall 108. The space S extends through and between the bottom wall 108 and a lower end of the partition wall 112, which divides the first adsorption chamber 114 and the second adsorption chamber 316. The space S mutually communicates the first adsorption chamber 114 and the second adsorption chamber 316. Therefore, a U-shaped fluid passage is defined in the casing 110 through which the fluid, i.e., the desorbed fuel vapor, flows.

The flow and diffusion of the adsorbed fuel vapor within the canister 300 are substantially the same as those of the above-described second embodiment, and therefore the description thereof will be omitted.

Similar to the first and second embodiments, during the purge process and the circulation process, the temperature of the adsorbents 102 in the first compartment 322 shown in FIG. 4 is lower than that of the surrounding areas. Consequently, the adsorption performance of the adsorbents 102 in the first compartment 322 is improved, compared to that of the adsorbents 102 in the other locations. Due to such improvement in the adsorption performance, diffusion of the adsorbed fuel vapor from the adsorbents 102 in the second compartment 324 and/or from the adsorbents 102 in the third compartment 326 to the adsorbents 102 in the first compartment 322 will be promoted.

Further, since the temperature of the adsorbents 102 in the first compartment 322 is lower than that of the surrounding areas during the purge process and the circulation process, the temperature of the desorbed fuel vapor drawn by the purge pump 52 from the first compartment 322 is relatively lower as well. The purge pump 52 can then be cooled with this lower temperature desorbed fuel vapor.

However, when the purge pump 52 shown in FIG. 1 is continuously driven, its temperature may rise. In response, the temperature of the desorbed fuel vapor exhausted from the purge pump 52 will correspondingly rise. Further, the adsorbents 102 in the second compartment 324 shown in FIG. 4 adsorb the exhausted fuel during the circulation process. Therefore, the temperature of the adsorbents 102 in the second compartment 324 becomes higher during the circulation process than the temperature of the adsorbents 102 located in the other locations. The high concentration of evaporated fuel generated in the fuel tank 10 flows from the vapor port 338 into the third compartment 326. Therefore, a reduction in the adsorption performance of the adsorbents 102 in the third compartment 326 is not desirable.

Similar to the first embodiment, the vapor port 338 may be located farther from the second purge port 336 than the first purge port 334. However, in the third embodiment shown in FIG. 4, the vapor port 338 may be positioned nearer the second purge port 336 than the first purge port 334.

In the third embodiment shown in FIG. 4, the thermal conductivity of the second compartment wall 320 may be set to be lower than the thermal conductivity of the casing 110. This makes the heat of the adsorbents 102 in the second compartment 324 more difficult to transfer to the adsorbents 102 in the third compartment 326, as compared with the case where the thermal conductivity of the second compartment wall 320 is equal to the thermal conductivity of the casing 110. As a result, it is possible to prevent deterioration of the adsorption performance of the adsorbents 102 in the third compartment 326, even when the circulation process is performed for long periods of time.

The second purge passage 44 shown in FIG. 4 may be opened or closed by the three-way valve 50 shown in FIG. 1. This makes it possible to switch flow passages between the second purge passage 44 and the first purge passage downstream portion 48 without complicated piping.

As shown in FIG. 4, the air layer L1 in the first compartment 322 may communicate with the air layer L2 in the second compartment 324 via the adsorbents 102. The adsorbed fuel vapor may be uniformly desorbed from the upper end face of the adsorbent layer of the adsorbents 102 in the first compartment 322 since the air layer L1 is provided. At the same time, the desorbed fuel vapor can be uniformly adsorbed over the upper end face of the adsorbent layer of the adsorbents 102 in the second compartment 324 since the air layer L2 is provided. Therefore, it is possible to perform adsorption and desorption more effectively than when any air chamber is not provided. Further, since the air layer L1 in the first compartment 322 communicates with the air layer L2 in the second compartment 324 via the adsorbents 102, direct leakage through the first compartment 322 and the second compartment 324 may be prevented. Accordingly, the adsorbed fuel vapor may be more intensively desorbed from the adsorbents 102 in the first compartment 322.

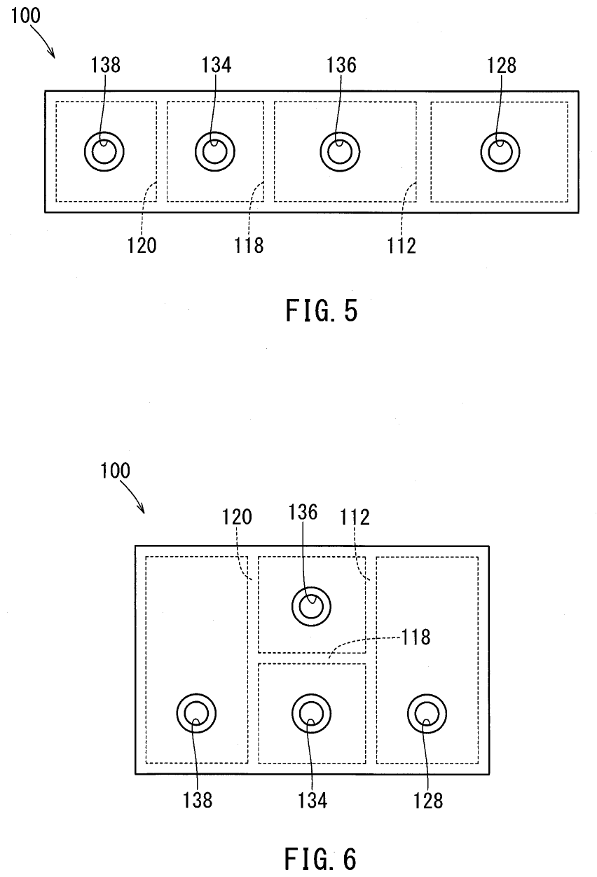

The evaporated fuel processing apparatus 56 disclosed in the present specification shall not be limited to the above-described embodiments, and various modifications may be made. For example, as shown in FIG. 5, the atmospheric port 128, the first purge port 134, the second purge port 136, and the vapor port 138 may be arranged in a straight line in the first embodiment. Alternatively, these ports may not be arranged in a straight line. For example, as shown in FIG. 6, the second purge port 136 may be arranged so as to be shifted in a front/rear direction (up and down direction in the figure), while the atmospheric port 128, the first purge port 134 and the vapor port 138 are arranged in a straight line.

In the third embodiment shown in FIG. 4, the second compartment wall 320 has a cavity inside. Alternative to this structure, the second compartment wall 320 may have a groove inside. Alternatively, the second compartment wall 320 may be formed of a material having lower thermal conductivity than that of the casing 110, the partition wall 112, and/or the first compartment wall 318. In this case, the second compartment wall 320 may or may not be formed with a cavity or a groove.

In the first to third embodiments, two or more two-way valves may be provided alternative to the three-way valve 50 shown in FIG. 1.

The fuel supply system 1 may be configured to be mounted on a vehicle other than an automobile. Each of the above-described passages may be formed by a piping(s) or a hole(s) or a groove(s) defined in a block. The canister 100 in FIG. 2 may include a second compartment wall 220 shown in FIG. 3 or a second compartment wall 320 shown in FIG. 4 alternative to the second compartment wall 120 shown in FIG. 2 and/or the first compartment wall 118 shown in FIG. 2.

The various examples described above in detail with reference to the attached drawings are intended to be representative of the present disclosure and are thus non-limiting embodiments. The detailed description is intended to teach a person of skill in the art to make, use and/or practice various aspects of the present teachings, and thus does not limit the scope of the disclosure in any manner. Furthermore, each of the additional features and teachings disclosed above may be applied and/or used separately or with other features and teachings in any combination thereof, to provide an improved evaporated fuel processing apparatus, and/or methods of making and using the same.

What is claimed is:

1. An evaporated fuel processing apparatus, comprising:
a canister configured to store adsorbents to releasably adsorb evaporated fuel from a fuel tank;
a first purge passage configured to communicate the canister with an intake passage of an internal combustion engine;
a purge pump disposed along the first purge passage;
an opening/closing valve disposed along the first purge passage between the purge pump and the intake passage; and
a second purge passage configured to communicate the opening/closing valve with the canister;
wherein the canister further comprises:
a vapor port leading to the fuel tank;
an atmospheric port leading to an atmosphere;
a first purge port leading to the first purge passage; and
a second purge port leading to the second purge passage;
wherein the vapor port is positioned farther from the second purge port than the first purge port.

2. An evaporated fuel processing apparatus, comprising:
a canister configured to store adsorbents to releasably adsorb evaporated fuel from a fuel tank;
a first purge passage configured to communicate the canister with an intake passage of an internal combustion engine;
a purge pump disposed along the first purge passage;
an opening/closing valve disposed along the first purge passage between the purge pump and the intake passage; and
a second purge passage configured to communicate the opening/closing valve with the canister;
wherein the canister further comprises:
a vapor port leading to the fuel tank;
an atmospheric port leading to an atmosphere;
a first purge port leading to the first purge passage;
a second purge port leading to the second purge passage; and
an adsorbent layer comprising the adsorbents, the adsorbent layer including a second end face facing the second purge port and a vapor end face facing the vapor port, and
wherein a distance between the vapor port and the vapor end face is greater than a distance between the second purge port and the second end face.

3. The evaporated fuel processing apparatus according to claim 2, wherein the vapor port is disposed closer the second purge port than the first purge port.

4. An evaporated fuel processing apparatus, comprising:
a canister configured to store adsorbents to releasably adsorb evaporated fuel from a fuel tank;
a first purge passage configured to communicate the canister with an intake passage of an internal combustion engine;
a purge pump disposed along the first purge passage;
an opening/closing valve disposed along the first purge passage between the purge pump and the intake passage; and
a second purge passage configured to communicate the opening/closing valve with the canister;
wherein the canister further comprises:
a vapor port leading to the fuel tank;
an atmospheric port leading to an atmosphere;
a first purge port leading to the first purge passage;
a second purge port leading to the second purge passage; and
an adsorbent layer comprising the adsorbents, the adsorbent layer including a region facing the second purge port and a region facing the vapor port, the regions being partitioned by a partition, and
wherein the partition is structured so that a thermal conductivity of the partition is lower than a thermal conductivity of a case member of the canister.

5. The evaporated fuel processing apparatus according to claim 4, wherein the vapor port is disposed closer to the second purge port than the first purge port.

6. The evaporated fuel processing apparatus according to claim 1, wherein the opening/closing valve is a three-way valve.

7. The evaporated fuel processing apparatus according to claim 1, wherein the canister further comprises:
a first purge air chamber adjacent to the first purge port;
a second purge air chamber adjacent to the second purge port; and
a second partition configured to partition the first purge air chamber and the second purge air chamber;
wherein the first purge air chamber and the second purge air chamber communicate with each other via an adsorbent layer comprising the adsorbents.

8. The evaporated fuel processing apparatus according to claim 1, wherein a distance between the second purge port and the atmospheric port is smaller than a distance between the first purge port and the atmospheric port.

9. The evaporated fuel processing apparatus according to claim 1, wherein a distance between the second purge port and the atmospheric port is larger than a distance between the first purge port and the atmospheric port.

10. The evaporated fuel processing apparatus according to claim 1, wherein a distance between the second purge port and the atmospheric port is larger than a distance between the second purge port and the first purge port.

11. The evaporated fuel processing apparatus according to claim 1, wherein a distance between the vapor port and the second purge port is smaller than a distance between the vapor port and the atmospheric port.

12. The evaporated fuel processing apparatus according to claim 1, wherein a distance between the second purge port and the vapor port is the same as a distance between the second purge port and the atmospheric port.

13. The evaporated fuel processing apparatus according to claim 1, wherein a distance between the first purge port and the vapor port is the same as a distance between the first purge port and the atmospheric port.

14. The evaporated fuel processing apparatus according to claim 1, wherein a distance between the second purge port and the vapor port is larger than a distance between the second purge port and the first purge port.
